(19) United States
(12) Patent Application Publication
(10) Pub. No.: US 2006/0153068 A1
(43) Pub. Date: Jul. 13, 2006

(54) Systems and methods providing high availability for distributed systems

(75) Inventors: John Dally, Monmouthshire (GB); Michael Doyle, Bristol (GB); Steve Hayward, Monmouthshire (GB); Gethin Liddell, Cardiff (GB); James Steadman, Swansea (GB)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Ubiquity Software Corporation, Redwood City, CA (US)

(21) Appl. No.: 11/016,337

(22) Filed: Dec. 17, 2004

(51) Int. Cl. G06F 11/00; H04J 3/14

(52) U.S. Cl. 370/219; 714/1

(57) ABSTRACT

Disclosed are systems and methods which provide high availability with respect to equipment deployed in a distributed system architecture. The distributed system architecture may comprise one or more equipment clusters of a plurality of processor-based systems cooperating to host one or more application servers. Redundancy is provided with respect to equipment of the equipment clusters to provide high availability with respect to equipment used in providing services of the application servers as well as to provide continuity of applications provided by the application servers. Various equipment elements of an equipment cluster may be provided different levels and/or types of redundancy. Other equipment elements of an equipment cluster may be provided different levels and/or types of redundancy. Equipment elements may operate to assign sessions to particular equipment elements for load balancing

### TECHNICAL FIELD

The present invention relates generally to distributed system environments and, more particularly, to providing high availability for distributed systems.

### BACKGROUND OF THE INVENTION

Equipment providing services with respect to various environments is often expected to provide high availability. For example, equipment utilized with respect to carrier based telecommunications environments is generally required to meet 99.999% (often referred to as “five nines”) availability. In providing high availability implementations, all critical elements within a deployment need to be redundant, with no single point of failure, and providing continuous service during an equipment failure without service being appreciably affected (e.g., all services seamlessly continued without appreciable delay or reduction in quality of service). The foregoing level of availability has traditionally been implemented in telecommunications environments by closely coupling the systems thereof, such as through disposing redundant equipment in a single equipment rack, hard wiring various equipment directly together, perhaps using proprietary interfaces and protocols, developing equipment designs dedicated for use in such environments, etcetera.

However, as general purpose processing systems, such as single or multi-processor servers, high speed data networking, and mass data storage have become more powerful and less expensive, many environments are beginning to adopt open architecture implementations. Equipment providing such open architecture implementations often does not itself provide 99.999% availability nor does such equipment typically directly provide a means by which such high availability may be achieved. For example, general purpose processor-based systems are not designed for a dedicated purpose and therefore may not include particular design aspects for ensuring high availability. Additionally, such equipment is often loosely coupled, such as in multiple discrete systems, perhaps distributed over a data network, such as a local area network (LAN), metropolitan area network (MAN), wide area network (WAN), the Internet, and/or the like, providing a distributed system architecture. Such implementations can present difficulty with respect to how the information that needs to be shared to make it available to the appropriate equipment is identified, how that information is communicated between the equipment, insuring the information gets distributed in a timely fashion to respond quickly in the event of a failure, how equipment failure is detected, etcetera. Accordingly, although providing flexible and cost effective solutions, the use of such equipment has often been at the sacrifice of robust and reliable high availability equipment implementations.

### BRIEF SUMMARY OF THE INVENTION

The present invention is directed to systems and methods which provide high availability with respect to equipment deployed in a distributed system architecture. For example, embodiments of the invention provide high availability with respect to an application server, such as may be deployed in a distributed system architecture to provide desired scalability. A distributed system architecture application server provided high availability according to embodiments of the present invention may accommodate one or a plurality of protocols, such as session initiation protocol (SIP), remote method invocation (RMI), simple object access protocol (SOAP), and/or the like where the application server provides services with respect to carrier based telecommunications environments, Enterprise networks, and/or the like.

The foregoing distributed system architecture may comprise one or more equipment clusters of a plurality of processor-based systems, e.g., open architecture processor-based systems such as general purpose processor-based systems. The processor-based systems of an equipment cluster preferably cooperate to host one or more application servers. Redundancy is provided with respect to equipment of the equipment clusters, according to embodiments of the present invention, to provide high availability with respect to equipment used in providing services of the application servers as well as to provide continuity of applications provided by the application servers.

Various equipment elements of an equipment cluster may be provided different levels and/or types of redundancy according to the present invention. For example, according to an embodiment of the invention equipment elements providing execution of an application server (referred to herein as a “service host”) are provided 1:N redundancy, such as through the use of a pool of equipment available to replace any of a plurality of service hosts. When a service host is determined to have failed, an equipment element from the pool of equipment may be assigned to replace the failed service host, and the failed service host may be restarted and added back to the pool of equipment or taken offline. The use of such a pool of equipment elements facilitates recovery from multiple subsequent failures according to embodiments of the invention.

Although the foregoing 1:N redundancy may be relied upon to provide high availability with respect to service hosts of an equipment cluster, such redundancy may not provide continuity of applications. Specifically, if a service host fails, it may be impossible to obtain information from that service host regarding the particular application sessions then being conducted by the service host. Moreover, even if such information may be obtained from the failed service host, transferring such information to equipment from the pool of equipment may require appreciable time, and thus result in unacceptable delays in application processing. Accordingly, although a service host may be quickly replaced from an equipment pool, thereby providing high availability, application processing in process may be disrupted or unacceptably delayed, thereby preventing application continuity.

Embodiments of the invention additionally or alternatively implement 1:1 redundancy with respect to service hosts of an equipment cluster, such as through the use of a primary/secondary or master/slave service host configuration. For example, an embodiment of the present invention provides service hosts in a paired relationship (referred to herein as a “service host channel” or “channel”) for one-to-one service host redundancy. Such a service host channel comprises a service host designated the primary service host and a service host designated the secondary service host. The primary service host will be utilized in providing application server execution and the secondary service host will duplicate particular data, such as session information and/or application information, needed to continue application processing in the event of a failure of the primary service host. If it is determined that the primary service host has failed, the secondary service host will be designated the primary service host and application processing will continue uninterrupted, thereby providing application continuity. The failed service host may be restarted or taken offline.

According to a preferred embodiment of the invention, both 1:N and 1:1 redundancy is implemented with respect to service hosts of an equipment cluster. In such an embodiment, a secondary service host may be designated to replace a failed primary service host and an equipment element from the pool of equipment may be assigned to replace the secondary service host, and the failed primary service host may be restarted and added back to the pool of equipment or taken offline.

Other equipment elements of an equipment cluster may be provided different levels and/or types of redundancy. For example, embodiments of the invention provide redundancy with respect to equipment elements (referred to herein as a “service director”) providing directing of service messages, load balancing, managing equipment failures, and/or managing equipment cluster topologies. According to embodiments of the invention, service directors are provided 1:N redundancy, such as through the use of a plurality of service directors operable interchangeably. In a preferred embodiment, one service director is identified as a primary or master service director to facilitate organized and controlled decision making, such as with respect to managing equipment failures and/or managing equipment cluster topologies. However, even in such an embodiment, each service director may operate to provide operation, such as to provide directing of service messages and load balancing. If the service controller identified as the primary or master service director is determined to have failed, another one of the service controllers may be identified as the primary or master service director, and the failed primary service director may be restarted and added back to the plurality or taken offline.

Service directors of embodiments of the invention may be hierarchically identified in the redundant plurality, such that when a primary service director fails a next service director in the hierarchy is promoted to the position of primary service director, and so on. Service directors of embodiments of the invention may be provided equal status in the redundant plurality, such that when a primary service director fails a next service director to be promoted to the position of primary service director is heuristically or otherwise determined.

Embodiments of the present invention may implement 1:1 redundancy in the alternative to or in addition to the aforementioned 1:N service director redundancy. For example, 1:1 redundancy in combination with 1:N redundancy, such as discussed above with reference to service hosts, may be implemented with respect to service directors. However, service directors of embodiments of the present invention need not share substantial information in order to enable application continuity. Accordingly, 1:1 redundancy may be foregone in favor of 1:N redundancy in such embodiments without incurring substantial communication overhead, unacceptable delays in application processing, or application discontinuity.

Service directors of embodiments of the invention operate to assign sessions to particular service hosts for load balancing, such as by directing an initial service request to a service host having a lowest load metric and causing all subsequent messages associated with the session to be tagged for provision to/from the particular service host. Embodiments of the present invention are adapted to provide the foregoing load balancing, and other service message directing, with respect to a plurality of protocols accommodated by an application server, such as SIP, RMI, and SOAP.

Various communications may be implemented with respect to the equipment elements of an equipment cluster in order to facilitate operation according to embodiments of the invention. For example, “heartbeat” signaling may be implemented to continuously monitor the operational status of equipment elements. According to embodiments of the invention, one equipment element of an equipment cluster, such as the primary service director, repeatedly conducts heartbeat signaling (e.g., transmits an “are you there” message and awaits a resultant “I am here” message) with respect to each equipment element of the equipment cluster to determine whether any equipment element has failed. Additionally or alternatively, service directors of embodiments of the invention may solicit or otherwise receive loading information, such as messages queued, messages served, central processing unit (CPU) or other resource utilization, etcetera, associated with equipment elements, such as service hosts, for directing service messages to provide load balancing.

Embodiments of the invention implement a management server or other supervisory system to provide administration, management, and/or provisioning functionality with respect to equipment of the equipment cluster. For example, a management server may provide functionality such as identifying a plurality of equipment elements as an equipment cluster, initially identifying a service director of an equipment cluster as a primary service director, establishing the types and/or levels of redundancy to be implemented in an equipment cluster, and/or the like.

The foregoing embodiments provide robust and reliable high availability equipment implementations, insuring no single point of failure of any critical traffic bearing element. Moreover, embodiments of the invention provide for continuity of applications in the event of equipment failure.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows a distributed system architecture adapted to provide high availability according to an embodiment of the present invention;

FIG. 2 shows a distributed system architecture adapted to provide high availability according to an embodiment of the present invention;

FIG. 3 shows detail with respect to equipment elements adapted according to an embodiment of the present invention;

FIG. 4 shows an equipment element redundant pool according to an embodiment of the invention; and

FIG. 5 shows a processor-based system as may be utilized as an equipment element according to an embodiment of the invention.

### DETAILED DESCRIPTION OF THE INVENTION

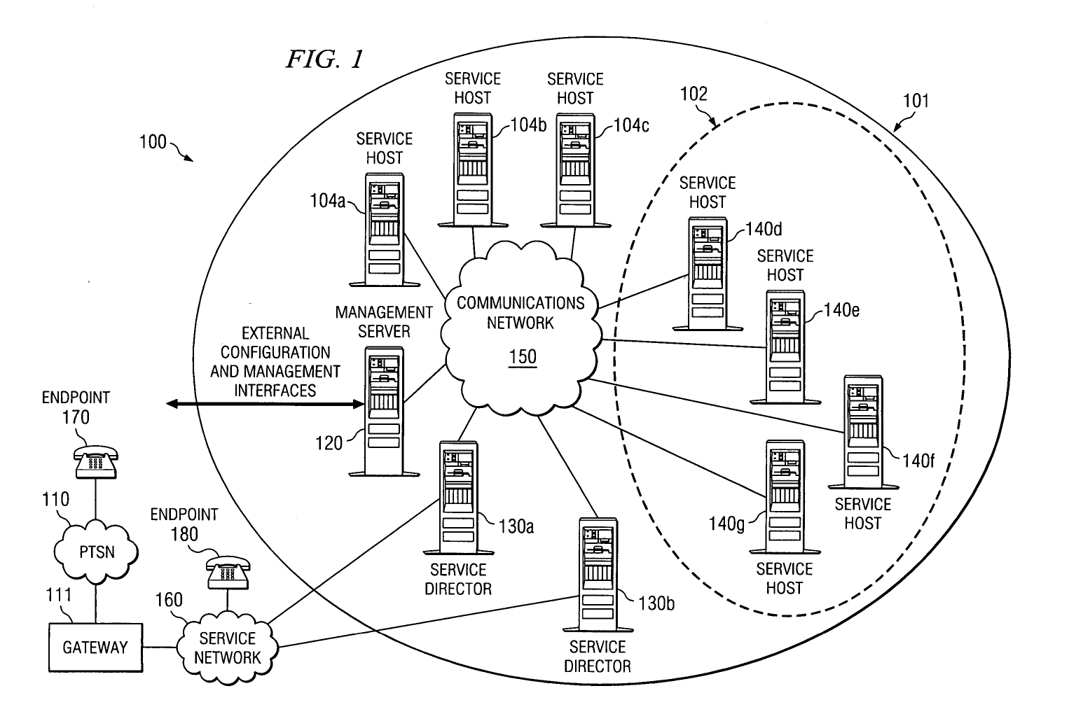

Directing attention to FIG. 1, distributed system architecture 100 is shown being provided high availability with respect to equipment deployed therein according to an embodiment of the present invention. Distributed system architecture 100 of the illustrated embodiment includes a plurality of equipment elements, shown here including management server 120, service directors 130a and 130b, and service hosts 140a-140g, associated with equipment cluster 101. It should be appreciated that the particular numbers of equipment elements and types illustrated in FIG. 1 are merely exemplary, and thus embodiments of the invention may comprise various numbers and configurations of equipment elements. Similarly, although only a single equipment cluster is shown in distributed system architecture 100 for simplicity, it should be appreciated that any number of equipment clusters, as may comprise various numbers and configurations of equipment elements and as may share one or more equipment elements, may be implemented according to embodiments of the invention. Moreover, although shown as comprising separate equipment elements in the embodiment of FIG. 1, the functions of various equipment elements, such as those of a management server, a service director, and/or a service host, may be consolidated in a same equipment element according to embodiments of the invention.

The equipment elements of the foregoing distributed system architecture comprise processor-based systems according to embodiments of the present invention. For example, management server 120, service directors 130a and 130b, and service hosts 140a-140g may comprise open architecture processor-based systems, such as general purpose processor-based systems. Equipment elements utilized according to embodiments of the invention are vertically and/or horizontally scalable. For example, an equipment element may adapted to accept a plurality of CPUs to provide linear vertical scalability. Likewise, additional equipment elements may be added to an equipment cluster to provide linear horizontal scalability.

Equipment elements of equipment cluster 101 provide one or more hosts for an application server environment according to embodiments of the present invention. For example, an application for providing services for one or more media types (e.g., voice, video, data, chat, etcetera) using one or more networks (e.g., circuit networks such as the public switched telephone network (PSTN), asynchronous transfer mode (ATM), etcetera and packet networks such as Internet protocol (IP), etcetera), such as the UBIQUITY SIP APPLICATION SERVER, available from Ubiquity Software Corporation, Redwood City, Calif., may be operable upon one or more equipment elements (e.g., service hosts 140a-140g) of equipment cluster 101 to provide services with respect to circuit network terminal equipment (e.g., endpoint 170, such as may comprise a telephone, computer, personal digital assistant (PDA), pager, etcetera of circuit network 110) and/or packet network terminal equipment (e.g., endpoint 180, such as may comprise an IP phone, computer, PDA, pager, etcetera of packet network 160). According to one embodiment, the processor-based systems of active ones of service hosts 140a-140g cooperate to host one or more application servers. For example, when an application is deployed with respect to equipment cluster 101, the application is preferably deployed across the entire cluster, such that each service host thereof provides operation according to the application although only currently active ones of the service hosts may actually process data using the application. Similarly, when multiple applications are deployed with respect to a cluster, each such application is preferably deployed across the entire cluster. Such configurations facilitates scalability and availability according to embodiments of the invention.

Additionally equipment elements of cluster 101 of the illustrated embodiment provide for directing service messages, load balancing, managing equipment failures, and/or managing equipment cluster topologies. For example, one or more equipment elements (e.g., service directors 130a and 130b) of equipment cluster 101 may be provided with failure management control functionality and/or topology management functionality to provide for management of equipment failures within equipment cluster and/or to manage an equipment topology of equipment cluster 101. Additionally or alternatively, one or more equipment elements (e.g., service directors 130a and 130b) of equipment cluster 101 may be provided with load metric analysis functionality to provide service message directing and/or load balancing.

Equipment elements of cluster 101 of the illustrated embodiment provide a management server or other supervisory system to provide administration, management, and/or provisioning functionality. For example, management server 120 may provide functionality such as identifying equipment elements 120, 130a and 130b, and 140a-140g as equipment cluster 101, initially identifying a service director of service directors 130a and 130b as a primary service director, establishing the types and/or levels of redundancy to be implemented in equipment cluster 101, and/or the like. Management server 120 of embodiments of the present invention provides an administration, management, and/or provisioning portal to equipment cluster 101, such as may be utilized by a service provider or other entity associated with distributed system architecture 100. Accordingly, management server 120 of the illustrated embodiment includes an external configuration and management interface, such as may provide communication via any of a number of communication links including a LAN, a MAN, a WAN, the Internet, the PSTN (e.g., using an IP service connection), a wireless link, an optical link, etcetera. Although a single management server is shown in the illustrated embodiment, it should be appreciated that embodiments of the invention may employ multiple such equipment elements, such as may use redundancy schemes as described herein and/or to provide scalability.

Network 110 of embodiments of the invention may comprise any of a number of circuit networks, such as the PSTN, an ATM network, a SONET network, etcetera. Networks 150 and 160 of embodiments of the invention may comprise any of a number of packet networks, such as an Ethernet network, a token ring network, the Internet, an intranet, an extranet, etcetera. Although networks 110 and 160 are shown for completeness, it should be appreciated that embodiments of the invention may operate to provide services to terminal equipment of circuit networks, packet networks, or combinations thereof.

The equipment elements of equipment cluster 101 are provided data communication via network 150, such as may comprise a LAN, a MAN, a WAN, the Internet, the PSTN, wireless links, optical links, and/or the like. Data communication is further shown as being provided between equipment elements of equipment cluster 101 and gateway 111. Gateway 111 may provide communication between a protocol utilized by equipment and/or applications of equipment cluster 101 (e.g., SIP, RMI, SOAP, etcetera) and a protocol utilized by network 110 (e.g., plain old telephone service (POTS), signaling system seven (SS7), synchronous optical network (SONET), synchronous digital hierarchy (SDH), etcetera). Where a network, terminal equipment, etcetera implements protocols directly compatible with those utilized by the equipment and/or applications of equipment cluster 101 (e.g., network 160 and/or endpoint 180, or where voice over Internet protocols (VoIP) are utilized by network 110) and the equipment and applications of equipment cluster 101, gateway 111 may be omitted, perhaps being replaced by a switch, router, or other appropriate circuitry.

Embodiments of the invention are adapted to provide high availability with respect to an application server or application servers deployed in distributed system architecture 100. Specifically, redundancy is preferably provided with respect to equipment elements of the equipment clusters, according to embodiments of the present invention, to provide high availability with respect to equipment used in providing services of the application servers as well as to provide continuity of applications provided by the application servers. Various equipment elements of an equipment cluster may be provided different levels and/or types of redundancy according to embodiments of the present invention.

An embodiment of the invention provides 1:N redundancy with respect to equipment elements of service hosts 140a-140g which provide execution of an application server. Other equipment elements of equipment cluster 101 may be provided different levels and/or types of redundancy, as will be discussed below.

As shown in FIG. 1, backup pool 102 comprises service hosts 140d-140g available to replace any of service hosts 140a-140c which are active in execution of an application server. It should be appreciated that the number of active service hosts and the number of service hosts in the backup pool may differ from that illustrated according to the concepts of the present invention.

When a service host is determined to have failed, a service host from backup pool 102 is preferably assigned to replace the failed service host, and the failed service host may be restarted and added to backup pool 102 or taken offline if a restart cannot be accomplished or operation does not otherwise appear stable. For example, if service host 140c were determined to have failed, a service host from backup pool 102, e.g., service host 140d, may be selected to replace failed service host 140c, thereby removing service host 140d from backup pool 102 and causing service host 140d to become active in execution of the application server. Service host 140c will preferably be removed from active execution of the application server for restarting, maintenance, and/or removal from equipment cluster 101. If service host 140c can be returned to service, such as through a restart or reset procedure, service host 140c may be added to backup pool 102 for use in replacing a failed service host.

It should be appreciated that the foregoing redundancy scheme provides 1:N redundancy because each active service host is provided availability to a plurality of redundant service hosts (N being the number of service hosts in backup pool 102). The 1:N redundancy provided above is a hybrid redundancy scheme in that the redundant service hosts are shared between each active service host. Such a redundancy scheme is particularly useful in providing high availability with respect to a plurality of equipment elements in a cost effective way, particularly where an appreciable number of failed service hosts are expected to be returned to service with a restart or reset procedure to clear a processor execution error or other “soft” errors. Although such a restart procedure may require sufficient time (e.g., 3-5 minutes) to cause disruption in service if a redundant equipment element were not available for immediate replacement, a restart may be completed in sufficient time to allow a relatively few backup pool equipment elements to provide redundancy with respect to a relatively large number of active equipment elements.

Although the foregoing 1:N redundancy may be relied upon to provide high availability with respect to service hosts of an equipment cluster, such redundancy may not provide continuity of applications operable thereon. Specifically, if a service host fails, it may be impossible to obtain information from that service host regarding the particular application sessions then being conducted by the service host. Moreover, even if such information may be obtained from the failed service host, transferring such information to a service host of backup pool 102 may require appreciable time, and thus result in unacceptable delays in application processing.

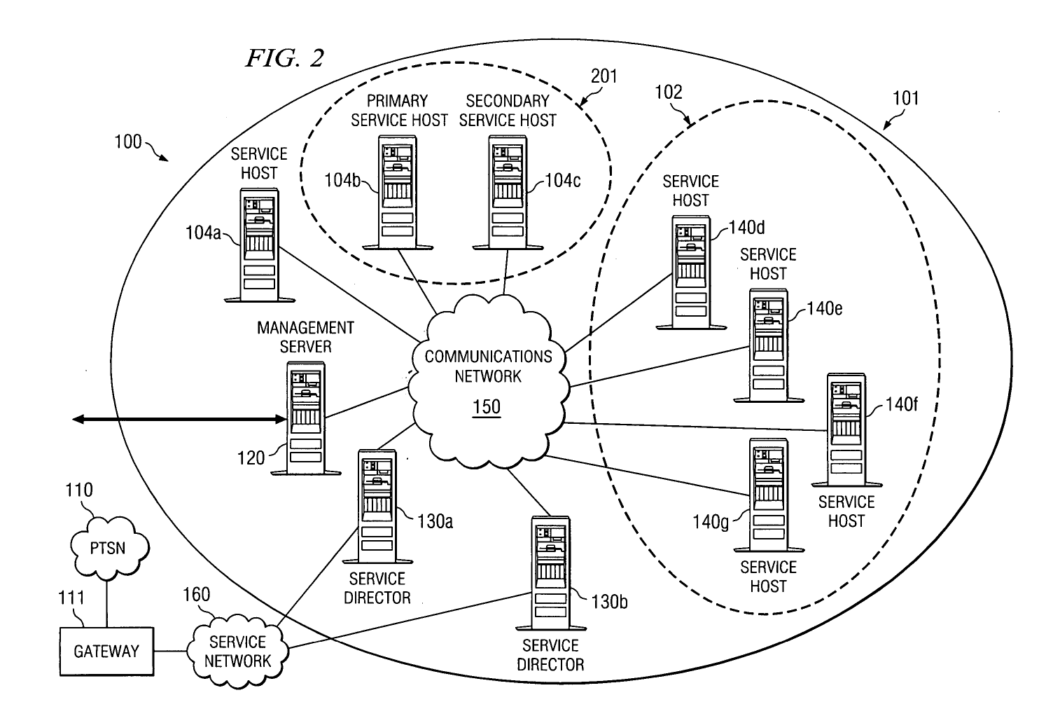

Embodiments of the invention implement 1:1 redundancy with respect to active ones of service hosts 140a-140g of equipment cluster 101. Directing attention to FIG. 2, an embodiment implementing a primary/secondary or master/slave service host configuration is shown. Specifically, the illustrated embodiment provides service hosts 140b and 140c in a paired relationship, shown as service host channel 201, for one-to-one service host redundancy. Service host channel 201 comprises service host 140b designated as the primary service host and service host 140c designated as the secondary service host. Primary service host 140b will be utilized in providing application server execution during normal operation of service host channel 201 and secondary service host 140c will be held in standby to replace primary service host 140b in the event of a failure of the primary service host. Accordingly, service host channel 201 provides a single logical service host during normal operation, although being comprised of a plurality of service hosts.

Secondary service host 140c of service host channel 201 duplicates particular data, such as session information and/or application information, needed to continue application processing in the event of a failure of primary service host 140b according to embodiments of the invention. Such duplicating may occur as a background task, may occur periodically, may occur as critical data is changed, created, and/or updated on the primary service host, etcetera. For example, at critical points within a session, a primary service host may push information to a corresponding secondary service host to duplicate the information that the secondary service host would need in order to recover the sessions should the primary service host fail. Duplicating of such data is preferably implemented in such a way as to optimize the possibility that the secondary service host will have sufficient and current data to provide application continuity in the event of a failure of a corresponding primary service host.

If it is determined that primary service host 140b has failed, secondary service host 140c will be designated the primary service host of service host channel 201 and application processing will continue uninterrupted, thereby providing application continuity. The failed primary service host 140b is preferably removed from active execution of the application server for restarting, maintenance, and/or removal from service host channel 201 and/or equipment cluster 101. If service host 140b can be returned to service, such as through a restart or reset procedure, service host 140b may designated the secondary service host of service host channel 201. Designation of service host 140b as the new secondary service host may include a process to duplicate data needed to continue application processing in the event of a failure of new primary service host 140c to new secondary service host 140b. Such duplicating may comprise copying session data and/or other data changed, created, and/or updated with respect to new primary service host 140c during a time in which new secondary service host 140b was offline.

Preferred embodiments of the invention, implement both 1:N and 1:1 redundancy with respect to service hosts of an equipment cluster. Accordingly, in the event of a failure of primary service host 140b, in addition to designating secondary service host 140c as the new primary service host to provide application continuity, a service host such as service host 140d from backup pool 102 is designated the new secondary service host of service host channel 201 according to embodiments of the invention. Designation of service host 140d as the new secondary service host may include a process to duplicate data needed to continue application processing in the event of a failure of new primary service host 140c to new secondary service host 140d. Failed primary service host 140b may be restarted and added back to backup pool 102 or taken offline.

It should be appreciated that, although the illustrated embodiment of service host channel 201 comprises two service hosts, embodiments of the present invention may implement any number of equipment elements in a equipment element channel such as service host channel 201. For example, the number of service hosts in service host channel 201 may be increased to accommodate a series of equipment element failures occurring in a time span too short to accommodate duplicating of data needed to continue application processing in the event of a failure of primary service host to a newly added secondary service host, to thereby facilitate application continuity by providing recovery from such multiple subsequent failures. However, duplicating of data between equipment elements of a equipment element channel consumes communication bandwidth and processing power and, therefore, embodiments of the invention balance the level of availability desired with system performance and infrastructure metrics in order to arrive at an optimal configuration.

The embodiment of FIG. 2 shows a single equipment element channel as service host channel 201. It should be appreciated that any number of such equipment element channels may be implemented as desired according to embodiments of the invention.

It can be readily appreciated from the above discussion that the topology of equipment cluster 101 may take any of a number of forms and may be subject to morphing or reconfiguration during operation. Moreover, the operational and/or hierarchal status of various equipment elements may change during operation. Accordingly, embodiments of the present invention provide equipment elements (shown in FIGS. 1 and 2 as service directors 130a and 130b) providing management functionality with respect to equipment elements of equipment cluster 101. Although two such service directors are shown in the illustrated embodiment, it should be appreciated that any number of such service directors may be implemented according to the concepts of the present invention.

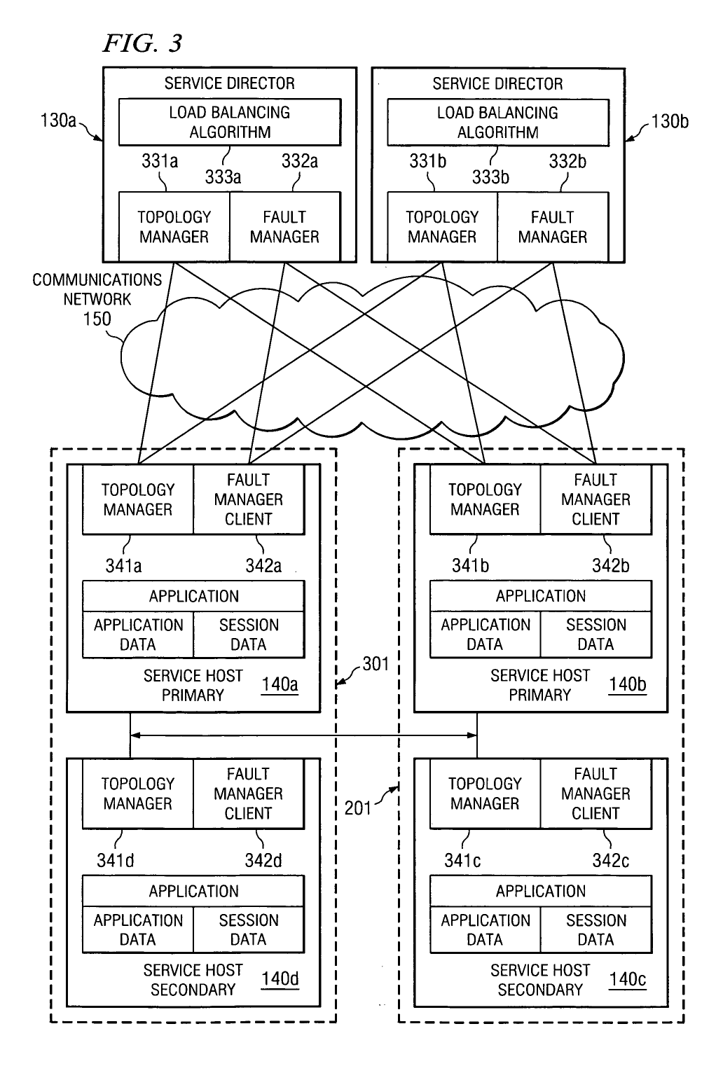

Embodiments of service directors 130a and 130b provide directing of service messages, load balancing, managing of equipment failures, and/or managing of equipment cluster topologies. Directing attention to FIG. 3, further detail with respect to the operation of service directors 130a and 130b of an embodiment is shown. In the embodiment of FIG. 3, in addition to service hosts 140b and 140c being configured in service host channel 201, service hosts 140a and 140d are configured in service host channel 301. Various equipment elements of equipment cluster 101 have been omitted from the illustration of FIG. 3 to simplify the drawing. However, each such equipment element is preferably provided one or more process functioning as described with respect to FIG. 3.

Service directors 130a and 130b of the illustrated embodiment comprise a plurality of processes therein operable to provide directing service messages, load balancing, managing equipment failures, and/or managing equipment cluster topologies. Specifically, FIG. 3 shows topology manager 331a, fault manager 332a, and load balancing algorithm 333a as processes operable within service director 130a and topology manager 331b, fault manager 332b, and load balancing algorithm 333b as processes operable within service director 130b.

The fault managers of service directors 130a and 130b are preferably in communication with corresponding fault manager clients (e.g., fault manager clients 342a-342d of service hosts 140a-140d) of other equipment elements of equipment cluster 101 and with each other. The various fault managers and fault manager clients of an equipment cluster preferably cooperate to determine the operational status of each equipment element of equipment cluster 101. Accordingly, although not directly shown in the illustration of FIG. 3, fault manager 332a and/or fault manager 332b may be in communication with each other and/or fault manager clients 342c and 342c to facilitate operational status determinations of the equipment elements of equipment cluster 101. Additionally or alternatively, communication to facilitate operational status determinations of the equipment elements may be provided in a cascade fashion from fault manager and/or fault manager client to fault manager and/or fault manager client, such as via the link between a primary service host and its corresponding secondary service host.

“Heartbeat” signaling may be implemented to continuously monitor the operational status of equipment elements. According to embodiments of the invention, the fault manager of one or both of service directors 130a and 130b (e.g., one of service directors 130a and 130b designated as a primary service director) repeatedly conducts heartbeat signaling with respect to each equipment element of equipment cluster 101 to determine whether any equipment element has failed. According to one embodiment, fault manager 332a or 332b associated with a service host of service hosts 130a and 130b designated as a primary service host transmits a brief heartbeat signal (e.g., an “are you there” message) to the fault manager or fault manager client of each equipment element, in turn, and awaits a brief acknowledgement signal (e.g., a resultant “I am here” message). The fault manager transmitting the heartbeat signal may wait a predetermined time (e.g., 10 seconds) for an acknowledgement signal, which if not received within the predetermined time causes the fault manager to determine that the particular equipment element is not operational.

Upon determining that an equipment element is not operational, embodiments of the fault manager operate to take steps to remove the non-operational equipment element from service or otherwise mitigate its effects on the operation of equipment cluster 101. For example, fault managers 332a and 332b preferably have information with respect to the redundancy levels and/or types implemented with respect to equipment cluster 101, such as may be stored in a database of the service director (e.g., stored during configuration by management server 120 during initialization). The fault manager may use this redundancy information in combination with current topology information, as may be provided by the topology manager, to determine an appropriate action with respect to the failed equipment element. For example, if the current topology information shows the failed equipment element as an active element, a corresponding redundant element may be designated to replace the failed equipment element. Where the failed equipment element is not active (e.g., a redundant equipment element or a member of a backup pool), the fault manager may designate another inactive equipment element to replace the failed equipment element in the topology and/or cause action to be taken to make the failed equipment element operational again (e.g., cause a restart, notify an administrator, etcetera).

Where the steps taken in response to a determination that an equipment element is not operational by a fault manager result in alteration to the equipment topology of equipment cluster 101, the fault manager preferably provides appropriate information to the topology manager to implement the topology change. For example, where fault manager 332a has determined that primary service host 140b is not operational, and thus has determined that secondary service host 140c should be designated the primary service host for service host channel 201, information is preferably provided to topology manager 331a to implement the topology change through communication with appropriate ones of the topology managers of equipment cluster 101. Such information may additionally cause a service host of backup pool 102 to be designated as the secondary service host for service host channel 201 and, if service host 140b can be made operational again, cause service host 140b to be designated as a part of backup pool 102.

The topology managers of service directors 130a and 130b are preferably in communication with corresponding topology managers (e.g., topology managers 341a-341d of service hosts 140a-140d) of other equipment elements of equipment cluster 101 and with each other. The various topology managers of an equipment cluster preferably cooperate to share a common view and understanding of the equipment element topology within the equipment cluster, or at least the portion of the topology relevant to the particular equipment element a topology manager is associated with. A current equipment element topology is preferably controlled by the topology manager of one or more service director (e.g., a primary service director, as discussed below). Accordingly, although not directly shown in the illustration of FIG. 3, topology manager 331a and/or topology manager 331b may be in communication with each other and/or topology managers 341c and 341d to ensure a consistent view of the equipment element topology of equipment cluster 101. Additionally or alternatively, communication to provide a consistent view of the equipment element topology may be provided in a cascade fashion from topology manager to topology manager, such as via the link between a primary service host and its corresponding secondary service host.

Service directors 130a and 130b of embodiments of the invention operate to assign sessions to service host channels 201 and 301 for load balancing, such as by directing an initial service request to a service host channel (active service host) using a predetermined load balancing policy (e.g., selecting a service host channel having a lowest load metric) and causing all subsequent messages associated with the session to be tagged for provision to/from the particular service host, application instance, and/or session instance. Accordingly, service directors 130a and 130b of the illustrated embodiment include load balancing algorithms 333a and 333b, respectively. Load balancing algorithms 333a and 333b of a preferred embodiment of the invention solicit or otherwise receive loading information, such as messages queued, messages served, central processing unit (CPU) or other resource utilization, etcetera, associated with equipment elements, such as primary service hosts 140a and 140b, for directing service messages to provide load balancing. For example, every time a service director communicates with a service host, information regarding the load (or from which load metrics may be determined) may be communicated to the service director for use by a load balancing algorithm thereof.

In operation according to a preferred embodiment, as a request to invoke a new session (e.g., a request for a service by a user terminal (e.g., endpoint 170 of network 110 or endpoint 180 of network 160) arrives at the application server of equipment cluster 101 via gateway 111 and one of service directors 130a and 130b) is received, the load balancing algorithm analyzes loading metrics with respect to equipment elements of equipment cluster 101 executing an application to conduct the session to determine an appropriate equipment element (or channel) for assignment of the session. Once a session is established in equipment cluster 101, state information is added by the load balancing algorithm to the messages associated with the session to facilitate the service director, or any service director of equipment cluster 101, routing subsequent messages associated with that session to the service host channel, service host, application instance, and/or session instance that is associated with that session. For example, where the session is initiated by a SIP inviting set from a remote client, the load balancing algorithm may determine which service host channel is most appropriate to start the new session, route the SIP inviting set to that service host channel, and cause state information to be added to the SIP message to identify the selected service host channel. It should be appreciated that, when a service director fails, the remaining service directors have the information necessary to continue the session because routing information is imbedded in the subsequent SIP messages. Similarly, if a service host associated with a session fails, the service directors have sufficient information to determine a replacement service host and may cause state information to be added to the SIP messages to identify the replacement service host.

Embodiments of the present invention are adapted to provide the foregoing load balancing, and other service message directing, with respect to a plurality of protocols accommodated by an application server, such as RMI and SOAP, in addition to or in the alternative to the above described SIP protocol. For example, a RMI client (e.g., a J2EE application) may make a request to get a handle to a service (e.g., a request for a service by a user terminal of network 110 arrives at the application server of equipment cluster 101 via gateway 111 and one of service directors 130a and 130b). The service director receiving the request will return an intelligent stub or other intelligent response back to the client according to an embodiment of the invention to associate the communications with a particular instance of a session. For example, the foregoing intelligent stub comprises one or more bits which associates the stub with a particular instance of a session. Accordingly, the load balancing algorithms may operate substantially as described above in selecting a service host to provide load balancing and causing subsequent messages associated with the session to be directed to the proper service host. It should be appreciated that the intelligent stub allows the service directors to make a failure of a service host transparent to the client user, such that if the process failed on a primary service host, and a backup service host was promoted, the intelligent stub facilitates the service directors detecting that the initial RMI connection failed and assigning another RMI intelligent stub which relates to the application instance and session instance on the backup service host.

The SOAP protocol may be addressed in a manner similar to the SIP behavior described above. For example, SOAP requests may be directed by a service director and, if the SOAP request is an initial SOAP request, it is directed to least loaded service host by the load balancing algorithm. Subsequent requests preferably have information within the SOAP messages which identify which particular service host, application instance, and/or session instance that message is destined for. In operation, the client application has no knowledge when there has been a change in the location of that application instance within equipment cluster 101.

As with the service hosts discussed above, embodiments of the invention provide redundancy with respect to the service directors of equipment cluster 101. However, service directors may be provided different levels and/or types of redundancy than other equipment elements, such as the service hosts. According to embodiments of the invention, service directors are provided 1:N redundancy, such as through the use of a plurality of service directors operable interchangeably.

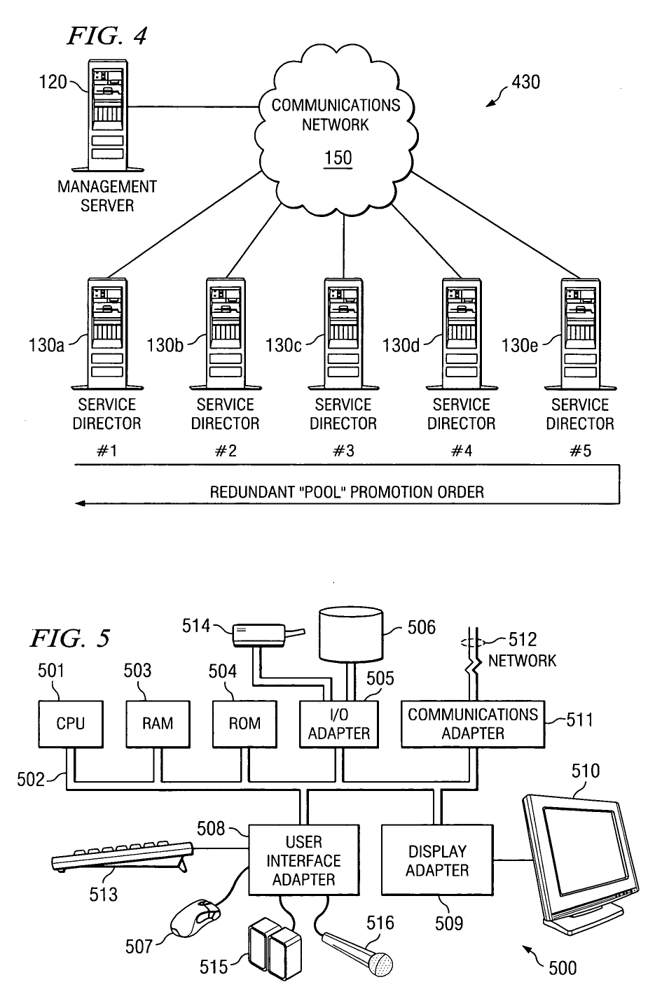

Directing attention to FIG. 4, service director redundant pool 430 is shown to include service directors 130a-130e. In a preferred embodiment, one service director of service director redundant pool 430 (e.g., service director 130a) is identified as a primary or master service director to facilitate organized and controlled decision making, such as with respect to managing equipment failures and/or managing equipment cluster topologies. The remaining service directors of service director redundant pool 430 may be hieratically ranked (e.g., secondary, tertiary, etcetera) or may be equally ranked within a backup pool. In the embodiment illustrated in FIG. 4, each of service directors 130b-130e is hieratically ranked (here 2-5) to provide a predefined service director promotion order. For example, if primary service director 130a is determined not to be operational, service director 130b is promoted to primary service director and service director 130a restarted and placed at the end of the promotion order or taken offline. Using such a hierarchal ranking, replacement of a failed service director may be accomplished in runtime without the intervention of a management system or other arbitrator. Of course, such a management system may be implemented, if desired, such as to promote service directors from a pool of equally ranked service directors, to initially establish a hierarchical ranking, etcetera.

For example, embodiments of the invention implement management server 120 to provide administration, management, and/or provisioning functionality with respect to equipment of the equipment cluster. Accordingly, management server 120 may initially identify service director 130a as the primary service director and make the hierarchal assignments with respect to service directors 130b-130e. Additionally or alternatively, management server 120 may operate to establish the types and/or levels of redundancy to be implemented in an equipment cluster and communicate that information to fault managers (e.g., fault managers 332a and 332b) and/or topology managers (e.g., topology managers 331a-331d). Management server 120 may establish the foregoing autonomously under control of an instruction set operable thereon, under control of input of an administrator or other user, or combinations thereof. Additionally or alternatively, management server 120 may provide an interface (see e.g., FIGS. 1 and 2) for an administrator or other user to query the status of equipment elements of equipment cluster 101, to download operation statistics and/or other information, to upload application revisions and/or other information, to change configuration settings and/or other information, etcetera.

It should be appreciated that each service director in service director redundant pool 430 may operate to provide directing of service messages and load balancing operations. For example, each service director of a preferred embodiment comprises a respective load balancing algorithm. Accordingly, irrespective of a particular service director of service director redundant pool 430 that gateway 111 (FIGS. 1 and 2) directs an initial request to, that service director is able to determine an appropriate service host to host the session. Moreover, because preferred embodiments of the invention provide subsequent messages of a session with information identifying the service host, application instance, and/or session instance any service director may properly direct subsequent messages for a session.

Embodiments of the present invention may implement 1:1 redundancy in the alternative to or in addition to the aforementioned 1:N service director redundancy. For example, 1:1 redundancy in combination with 1:N redundancy, such as discussed above with reference to service hosts, may be implemented with respect to service directors. However, service directors of embodiments of the present invention need not share substantial information in order to enable application continuity. Accordingly, 1:1 redundancy may be foregone in favor of 1:N redundancy in such embodiments without incurring substantial communication overhead, unacceptable delays in application processing, or application discontinuity.

Directing attention to FIG. 5, an embodiment of a processor-based system as may be utilized in providing a management server, a service director, and/or a service host according to embodiments of the invention is shown as processor-based system 500. In the illustrated embodiment of processor-based system 500, central processing unit (CPU) 501 is coupled to system bus 502. CPU 501 may be any general purpose CPU, such as an HP PA-8500 or Intel PENTIUM processor. However, the present invention is not restricted by the architecture of CPU 501 as long as CPU 501 supports the inventive operations as described herein. Bus 502 is coupled to random access memory (RAM) 503, which may be SRAM, DRAM, SDRAM, etcetera. ROM 504 is also coupled to bus 502, which may be PROM, EPROM, EEPROM, etcetera. RAM 503 and ROM 504 hold user and system data, applications, and instruction sets as is well known in the art.

Bus 502 is also coupled to input/output (I/O) controller card 505, communications adapter card 511, user interface card 508, and display card 509. I/O adapter card 505 connects to storage devices 506, such as one or more of a hard drive, a CD drive, a floppy disk drive, a tape drive, to the computer system. The I/O adapter 505 is also connected to printer 514, which would allow the system to print paper copies of information such as document, photographs, articles, etc. Note that the printer may be a printer (e.g. dot matrix, laser, etc.), a fax machine, or a copier machine. Communications card 511 is adapted to couple the computer system 500 to network 512 (as may correspond to network 150 of FIGS. 1-3), which may comprise a telephone network, a local (LAN) and/or a wide-area (WAN) network, an Ethernet network, the Internet, and/or the like. User interface card 508 couples user input devices, such as keyboard 513, pointing device 507, and microphone 516, to the computer system 500. User interface card 508 also provides sound output to a user via speaker(s) 515. The display card 509 is driven by CPU 501 to control the display on display device 510.

It should be appreciated that the processor-based system configuration described above is only exemplary of that which may be implemented according to the present invention. Accordingly, a processor-based system utilized according to the present invention may comprise components in addition to the alternative to those described above. For example, a processor-based system utilized according to embodiments of the invention may comprise multiple network adaptors, such as may be utilized to pass SIP traffic (or other service traffic) through one network adaptor and other traffic (e.g., management traffic) through another network adaptor.

When implemented in software, elements of the present invention may comprise code segments to perform the described tasks. The program or code segments can be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Although embodiments have been described herein with reference to management servers, service directors, and service hosts provided in separate processor-based systems, it should be appreciated that combinations of the foregoing may be provided within a same processor-based system. Scalability may be achieved by disposing one or more of the foregoing in separate processor-based systems and/or multiple processor-based systems (horizontal scalability). Additional scalability may be achieved by providing multiple processors and/or other resources within processor-based systems utilized according to the present invention (vertical scalability).

Although embodiments of the invention have been described wherein multiple applications are deployed across the entire cluster. Embodiments of the present invention may implement a plurality of equipment clusters, similar to that shown in FIGS. 1 and 2, to provide separate application server environments, such as for providing scalability with respect to various applications.

It should be appreciated that the concepts of the present invention are not limited in use to the equipment clusters shown herein. For example, high availability as provided by the concepts of the present invention may be applied to multiple equipment cluster configurations. For example, a single backup pool may be utilized to provide equipment elements for a plurality of equipment clusters. Additionally or alternatively, entire equipment clusters may be made redundant according to the concepts described herein.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
a plurality of equipment elements disposed in a distributed architecture cooperating to provide an application server, wherein a set of active equipment elements of said plurality of equipment elements is provided a first type of redundancy by a first set of standby equipment elements and said set of active equipment elements is provided a second type of redundancy by a second set of standby equipment elements.

2. The system of claim 1, wherein said set of active equipment elements comprises service hosts operable to execute an application of said application server.

3. The system of claim 1, wherein said first set of standby equipment elements comprise equipment elements uniquely configured to replace a corresponding equipment element of said set of active equipment elements, and wherein said second set of standby equipment elements comprise equipment elements configured to replace any equipment element of said set of active equipment elements.

4. The system of claim 1, wherein said first type of redundancy comprises 1:1 redundancy and said second type of redundancy comprises 1:N redundancy.

5. The system of claim 4, wherein said 1:N redundancy is configured to provide recovery of active elements of said set of active equipment elements from multiple subsequent failures.

6. The system of claim 1, wherein said first type of redundancy provides application continuity with respect to said application server, and wherein said first and second types of redundancy provide high availability with respect to said application server.

7. The system of claim 1, wherein said application server comprises a carrier based telephony services application.

8. The system of claim 7, wherein said carrier based telephony services application services requests submitted according to the session initiation protocol (SIP).

9. The system of claim 7, wherein said carrier based telephony service application services requests submitted according to the remote method invocation (RMI) protocol.

10. The system of claim 7, wherein said carrier based telephony service application services requests submitted according to the simple object access protocol (SOAP).

11. The system of claim 1, wherein said application server comprises an Enterprise network application.

12. The system of claim 11, wherein said Enterprise network application services requests submitted according to the session initiation protocol (SIP).

13. The system of claim 7, wherein said Enterprise network application services requests submitted according to the remote method invocation (RMI) protocol.

14. The system of claim 7, wherein said carrier Enterprise network application services requests submitted according to the simple object access protocol (SOAP).

15. The system of claim 1, wherein said plurality of equipment elements includes a set of equipment elements providing management with respect to said first and second types of redundancy.

16. The system of claim 15, wherein said set of active equipment elements comprises service hosts operable to execute an application of said application server and said set of equipment elements providing management comprises service directors operable to control replacement of failed ones of said set of active equipment elements with equipment elements of said first and second sets of standby equipment elements.

17. The system of claim 15, wherein equipment elements of said set of equipment elements providing management comprise a fault manager process operable to determine an operational state of equipment elements of said plurality of equipment elements.

18. The system of claim 17, wherein equipment elements of said active equipment elements and said first and second sets of standby equipment elements comprise a fault manager client process cooperative with said fault manager process for determining the operational state of an associated equipment element.

19. The system of claim 17, wherein said fault manager process utilizes heartbeat signaling in determining the operational state of equipment elements.

20. The system of claim 17, wherein said fault manager process is further operable to determine an equipment element from said first set of standby equipment to replace an equipment element of said active set determined to have failed and to determine an equipment element from said second set of standby equipment to replace said equipment element from said first set of standby equipment determined to replace said equipment of said active set determined to have failed.

21. The system of claim 15, wherein equipment elements of said set of equipment elements providing management comprise a topology manager process operable to control a topology of equipment elements of said plurality of equipment elements.

22. The system of claim 21, wherein equipment elements of said active equipment elements and said first and second sets of standby equipment elements comprise a topology manager process cooperative with said topology manager process of said equipment elements providing management for controlling said topology of equipment elements.

23. The system of claim 15, wherein equipment elements of said equipment elements providing management comprise a load balancing algorithm.

24. The system of claim 23, wherein said load balancing algorithm operates to assign initial requests for a session to an equipment element of said set of active equipment elements having a lowest load.

25. The system of claim 23, wherein said load balancing algorithm operates to monitor equipment elements of said set of active equipment elements to determine load metrics.

26. The system of claim 23, wherein said load balancing algorithm operates to cause information to be embedded in subsequent messages associated with a session from which an equipment element of said set of active equipment elements associated with said session can be determined.

27. The system of claim 15, wherein equipment elements of said set of equipment elements providing management are provided redundancy separate from redundancy provided by said first and second sets of standby equipment.

28. The system of claim 27, wherein said redundancy provided said equipment elements of said set of equipment elements providing management comprises a hierarchical pool of equipment elements.

29. The system of claim 27, wherein said redundancy provided said equipment elements of said set of equipment elements providing management comprises 1:N redundancy.

30. The system of claim 29, wherein said 1:N redundancy is configured to provide recovery of active elements of said equipment elements providing management from multiple subsequent failures.

31. A system comprising:
an equipment element cluster having a plurality of equipment elements disposed in a distributed architecture cooperating to provide an application server, wherein a first equipment element configuration of said plurality of equipment elements is provided a first type of redundancy and a second equipment configuration of said plurality of equipment elements is provided a second type of redundancy.

32. The system of claim 31, wherein said first type of redundancy comprises 1:1 redundancy and said second type of redundancy comprises 1:N redundancy.

33. The system of claim 31, wherein said first type of redundancy comprises a hybrid 1:N redundancy and said second type of redundancy comprises 1:N redundancy.

34. The system of claim 31, wherein at least one of said first and second type of redundancy is adapted to provide recovery from multiple subsequent failures.

35. The system of claim 31, wherein said first type of redundancy provides equipment elements configured to replace any equipment element of said first equipment element configuration, and wherein said second type of redundancy provides equipment elements uniquely configured to replace a corresponding equipment element having said second equipment element configuration.

36. The system of claim 31, wherein said first type of redundancy provides application continuity with respect to said application server, and wherein said first and second types of redundancy provide high availability with respect to said application server.

37. The system of claim 31, wherein said first equipment element configuration is further provided a third type of redundancy.

38. The system of claim 37, wherein said first type of redundancy comprises 1:1 redundancy and said third type of redundancy comprises 1:N redundancy.

39. The system of claim 31, wherein said first equipment element configuration comprises a set of active equipment elements operable to execute an application of said application server, and wherein said second equipment element configuration comprises a set of equipment elements providing management with respect to said first and second types of redundancy.

40. The system of claim 39, wherein equipment elements of said set of equipment elements providing management comprise a fault manager process operable to determine an operational state of equipment elements of said plurality of equipment elements.

41. The system of claim 39, wherein equipment elements of said set of equipment elements providing management comprise a topology manager process operable to control a topology of equipment elements of said plurality of equipment elements.

42. The system of claim 39, wherein equipment elements of said equipment elements providing management comprise a load balancing algorithm operable to determine an appropriate equipment element for conducting a session as a function of a load on said equipment element.

43. A method comprising:
disposing a plurality of equipment elements in a distributed architecture to provide an application server environment;
providing a first type of equipment element redundancy with respect to a set of active equipment elements of said plurality of equipment elements using a first set of standby equipment elements; and
providing a second type of equipment redundancy with respect to said set of active equipment elements using a second set of standby equipment elements.

44. The method of claim 43, wherein said set of active equipment elements comprises service hosts operable to execute an application of said application server.

45. The method of claim 43, wherein said first set of standby equipment elements comprise equipment elements uniquely configured to replace a corresponding equipment element of said set of active equipment elements, and wherein said second set of standby equipment elements comprise equipment elements configured to replace any equipment element of said set of active equipment elements.

46. The method of claim 43, wherein said first type of equipment element redundancy comprises 1:1 redundancy and said second type of redundancy comprises 1:N redundancy.

47. The method of claim 43, wherein said first type of equipment element redundancy provides application continuity with respect to said application server, and wherein said first and second types of equipment element redundancy provide high availability with respect to said application server.

48. The method of claim 43, wherein said application server comprises a carrier based telephony services application.

49. The method of claim 48, wherein said carrier based telephony services application services requests submitted according to the session initiation protocol (SIP).

50. The method of claim 48, wherein said carrier based telephony service application services requests submitted according to the remote method invocation (RMI) protocol.

51. The method of claim 48, wherein said carrier based telephony service application services requests submitted according to the simple object access protocol (SOAP).

52. The method of claim 43, wherein said application server comprises an Enterprise network application.

53. The method of claim 52, wherein said Enterprise network application services requests submitted according to the session initiation protocol (SIP).

54. The method of claim 52, wherein said Enterprise network application services requests submitted according to the remote method invocation (RMI) protocol.

55. The method of claim 52, wherein said Enterprise network application services requests submitted according to the simple object access protocol (SOAP).

56. The method of claim 43, wherein said plurality of equipment elements includes a set of equipment elements providing management with respect to said first and second types of equipment element redundancy.

57. The method of claim 56, wherein said set of active equipment elements comprises service hosts operable to execute an application of said application server and said set of equipment elements providing management comprises service directors operable to control replacement of failed ones of said set of active equipment elements with equipment elements of said first and second sets of standby equipment elements.

58. The method of claim 56, wherein equipment elements of said set of equipment elements providing management comprise a fault manager process operable to determine an operational state of equipment elements of said plurality of equipment elements.

59. The method of claim 58, wherein said fault manager process utilizes heartbeat signaling in determining the operational state of equipment elements.

60. The method of claim 58, wherein said fault manager process is further operable to determine an equipment element from said first set of standby equipment to replace an equipment element of said active set determined to have failed and to determine an equipment element from said second set of standby equipment to replace said equipment element from said first set of standby equipment determined to replace said equipment of said active set determined to have failed.

61. The method of claim 56, wherein equipment elements of said set of equipment elements providing management comprise a topology manager process operable to control a topology of equipment elements of said plurality of equipment elements.

62. The method of claim 56, wherein equipment elements of said equipment elements providing management comprise a load balancing algorithm.

63. The method of claim 62, wherein said load balancing algorithm operates to assign initial requests for a session to an equipment element of said set of active equipment elements having a lowest load.

64. The method of claim 62, wherein said load balancing algorithm operates to cause information to be embedded in subsequent messages associated with a session from which an equipment element of said set of active equipment elements associated with said session can be determined.

65. The method of claim 56, wherein equipment elements of said set of equipment elements providing management are provided redundancy separate from redundancy provided by said first and second sets of standby equipment.

66. The method of claim 65, wherein said redundancy provided said equipment elements of said set of equipment elements providing management comprises a hierarchical pool of equipment elements.

67. The method of claim 65, wherein said redundancy provided said equipment elements of said set of equipment elements providing management comprises 1:N redundancy.

68. The method of claim 43, further comprising:
providing linear scalability through the addition of equipment elements to said set of active equipment elements.

69. The method of claim 43, further comprising:
providing linear scalability through the addition of processors to equipment elements of said set of active equipment elements.

70. A method comprising:
disposing a plurality of equipment elements in a distributed architecture to provide an application server environment;
providing a first type of equipment element redundancy with respect to a first equipment element configuration of said plurality of equipment elements; and
providing a second type of equipment element redundancy with respect to a second equipment configuration of said plurality of equipment elements.

71. The method of claim 70, wherein said first type of equipment element redundancy comprises 1:1 redundancy and said second type of equipment element redundancy comprises 1:N redundancy.

72. The method of claim 70, wherein said first type of equipment element redundancy comprises a hybrid 1:N redundancy and said second type of equipment element redundancy comprises 1:N redundancy.

73. The method of claim 70, wherein said first type of equipment element redundancy provides equipment elements configured to replace any equipment element of said first equipment element configuration, and wherein said second type of equipment element redundancy provides equipment elements uniquely configured to replace a corresponding equipment element having said second equipment element configuration.

74. The method of claim 70, wherein said first type of equipment element redundancy provides application continuity with respect to said application server, and wherein said first and second types of equipment element redundancy provide high availability with respect to said application server.

75. The method of claim 70, wherein said first equipment element configuration is further provided a third type of equipment element redundancy.

76. The method of claim 75, wherein said first type of equipment element redundancy comprises 1:1 redundancy and said third type of equipment element redundancy comprises 1:N redundancy.

77. The method of claim 70, wherein said first equipment element configuration comprises a set of active equipment elements operable to execute an application of said application server, and wherein said second equipment element configuration comprises a set of equipment elements providing management with respect to said first and second types of redundancy.

78. The method of claim 77, wherein equipment elements of said set of equipment elements providing management comprise a fault manager process operable to determine an operational state of equipment elements of said plurality of equipment elements.

79. The method of claim 77, wherein equipment elements of said set of equipment elements providing management comprise a topology manager process operable to control a topology of equipment elements of said plurality of equipment elements.

80. The method of claim 77, wherein equipment elements of said equipment elements providing management comprise a load balancing algorithm operable to determine an appropriate equipment element for conducting a session as a function of a load on said equipment element.
